(19) United States
(12) Patent Application Publication
(10) Pub. No.: US 2019/0011728 A1
(43) Pub. Date: Jan. 10, 2019

(54) METHOD FOR THE PRODUCTION OF A PAIR OF CONTACT LENSES FOR THE IMPROVEMENT OF THE VISUAL PERFORMANCE IN PATIENTS WITH KERATOCONUS, AS WELL AS A SET OF LENSES

(71) Applicant: OCULENTI B.V., Zoetermeer (NL)

(72) Inventor: Christiaan Jacobus Hubertus FRAMBACH, Zoetermeer (NL)

(21) Appl. No.: 16/070,278

(22) PCT Filed: Jan. 14, 2017
(86) PCT No.: PCT/NL2017/050018

§ 371 Date: Jul. 15, 2018

(30) Foreign Application Priority Data
Jan. 15, 2016 (NL) 2016104

(51) Int. Cl. G02C 7/04

(52) U.S. Cl. CPC G02C 7/047; G02C 7/048

(57) ABSTRACT

In a method for the manufacture of a pair of contact lenses for the improvement of visual acuity in patients with keratoconus corrected with hard or soft contact lenses, use is made of a set of rotation-stabilized fitting lenses with different anterior optics, of which a sector at the inferior part of the fitting lens has a more positive or negative power than the remaining part of the anterior optics. First, it is determined which of the patient's eyes has the lowest degree of keratoconus. Then, for that eye, the most effective fitting lens—the one with which the patient can see best—is determined from the set of fitting lenses by applying different fitting lenses of that set of fitting lenses one by one to that eye while the patient looks with both eyes at optotypes. Thereafter, this is repeated for the other eye of the patient. Then, spherical fitting lenses with different powers are held in front of each eye in order to determine the basic power of the contact lenses to be manufactured. Then, a contact lens is manufactured for each eye with a power equal to that of the fitting lenses chosen that has a sector with a power equal to the sum of the power of the sector of the selected fitting lens and the power of the fitting lens.

### BACKGROUND OF THE INVENTION

### Field of the Invention

The invention relates to a method for the manufacture of a pair of rotationally stabilized hard or soft contact lenses for improving visual acuity in patients with keratoconus corrected with hard or soft contact lenses.

Keratoconus is an eye condition in which a part of the cornea which is partly in front of the pupil slowly becomes thinner and a cone-shaped deformation (conus) forms at the site of this thinner part. The eye condition starts in puberty and can be progressive until the age of 40. Keratoconus occurs in both eyes but is asymmetrical in gradation. Keratoconus is estimated to occur in one out of 1,500 persons. A keratoconus patient's first symptom is blurred and/or double vision with one eye. With normal refraction with spherical and cylindrical lenses, it is often not possible to correct the blur and the shadowy double images. Generally, the best way to correct the visual deficit in keratoconus is with hard contact lenses. Hard contact lenses generally give better correction in keratoconus than a pair of glasses.

Contact lenses fitted in patients with keratoconus have a special geometry that spares the superior part of the conus as much as possible. Hard contact lenses can be corneal, scleral or hybrid contact lenses.

One of the symptoms of uncorrected optics with keratoconus is that when looking at optotypes on a letter chart, a typical orientation-specific shadow formation occurs at the inferior part. After correction with glasses or soft contact lenses, this shadow formation at the inferior part of the optotypes remains unchanged. After correction with a hard contact lens, the keratoconus patient has better vision; a smaller typical orientation-specific shadow formation now occurs at the top of the letters.

The typical orientation-specific shadow formation on optotypes in the uncorrected keratoconus patient is caused by the fact that the wavefront is deflected more strongly at the location of the conus (see FIG. 1). The shadow that occurs after correction with a hard contact lens at the superior part of the letters is caused by the light at the location of the conus travelling a shorter path in comparison with the path of the light in the rest of the pupil (see FIG. 2).

The path of a wavefront that passes the optical elements of the eye is measured with aberrometry. Zernike polynomials are mathematical representations that describe the errors of the wavefront. Tilt, coma, secondary astigmatism, trefoil and tetrafoil are polynomials that characteristically occur in patients with keratoconus.

The reduction of visual acuity in young keratoconus patients starts unilaterally. This reduction, at the beginning of the disease, occurs gradually, with adaptation partially compensating for the decrease in unilateral visual acuity. Keratoconus patients confirm the monocular visual simulation by aberrometers. However, the binocular perception does not match. Binocular summation compensates (partially) for the asymmetrical blurring, resulting in better visual acuity. In persons with large quantities of uncorrected higher order aberrations, the binocular summation ratio can improve the contrast sensitivity values by a factor of 1.4. In practical terms, this means that patients with keratoconus binocularly experience less shadowy double images. This also means, however, that full correction of the aberrations, achieved by unilateral measurements with the aberrometer or adaptive optics of a patient with keratoconus does not yield the best correction. This correction can also overlook the adaptation that a patient with keratoconus has already undergone for the specific blurring. Patients with normal eyes looking through the simulated perspective of a keratoconus patient have poorer visual acuity than the keratoconus patient with the same optical characteristics. With complete correction executed with measurements through aberrometry or adaptive optics, it is possible that the desired correction may not be achieved because binocular summation that is controlled from the visual cortex is overlooked. Through adaptation to the specific blurring of keratoconus and the presence of improvement of visual acuity through binocular summation, subjective refraction may be a better method for achieving a correction of the most bothersome wavefront errors.

### Prior Art

A kit with higher order aberration contact lenses and methods of use is known from U.S. Pat. No. 8,894,208A. This kit of contact lenses comprises two or more contact lenses with a known higher order aberration for each given lens power. As an example, the higher order aberration may comprise spherical aberration, a coma aberration or a trefoil aberration. A specialist selects a fitting lens from the kit and applies the fitting lens to the eye of the patient and measures a residual higher order aberration of the lens-eye system. If the residual higher order aberration exceeds a predetermined magnitude, the specialist selects a second fitting lens from the kit, applies the second fitting lens to the eye of the patient and measures the residual higher order aberration of the lens-eye system. This is repeated until the fitting lens is found that yields the best results.

The disadvantage of this known method is that it requires an aberrometer that is not present in every ophthalmological practice.

From US2013297015A a wavefront corrected lens is known that is obtained from measurements with an aberrometer. By making use of the Zernike polynomials, it is possible to apply the unique patient-related wavefront to the anterior of the lens using lathe-cut technology. A specialist selects a fitting lens from the fitting set or measures over the already fitted lens, with which the wavefront of the patient is established. The uncorrected higher order aberrations are added as optical correction to the already present basic power. The disadvantage of this system is that the patient has no control over the visual end result; it ignores the adaptation of the patient and the capacity for binocular summation.

### SUMMARY OF THE INVENTION

An objective of the invention is to provide a method for obtaining a pair of rotation-stabilized hard or soft lenses for the improvement of visual acuity in patients with keratoconus corrected with hard or soft lenses, whereby it is not necessary to use an aberrometer or adaptive optics. To this end, the method according to the invention is characterized in that it comprises the following steps:
providing a set of more than two rotation-stabilized fitting lenses with different anterior optics, whereby a sector of each fitting lens has a more positive power than the remainder of the anterior optics for patients in whom keratoconus has been corrected with hard contact lenses or whereby a sector of each fitting lens has a more negative power than the remaining part of the anterior optics for patients in whom keratoconus has been corrected with soft contact lenses, whereby the more positive or negative sector is located at the inferior part of the rotation-stabilized fitting lens,
determining which eye of the patient has the lowest degree of keratoconus and is thus the better eye,
determining the most effective fitting lens from the set of fitting lenses for the eye with the least amount of keratoconus by applying different fitting lenses of the set of fitting lenses one by one to that eye, while the patient looks with both eyes at optotypes of a letter chart, whereby the most effective fitting lens is the fitting lens for that eye regarding which the patient says that they can see best with it,
determining the most effective fitting lens from the set of fitting lenses for the eye with the highest degree of keratoconus by applying different fitting lenses of the set of fitting lenses one by one to that eye, while the patient looks with both eyes at the reference object, and to the eye with the least amount of keratoconus the most effective fitting lens determined earlier is applied, whereby the most effective fitting lens is the fitting lens for the eye with the highest degree of keratoconus regarding which the patient states that they can see best with it,
determining the basic power of the contact lenses to be manufactured by holding spherical fitting lenses with different powers one by one in front of each eye, whereby the best basic power is the power of the fitting lenses with which that eye has the greatest acuity, and
manufacturing a contact lens for each eye of the patient with a power equal to that of the fitting lens with which that eye has the greatest acuity, and that has a sector with a power equal to the sum of the power of the sector of the selected most effective fitting lens for that eye and the power of the fitting lens with which that eye has the greatest acuity.

It has been found that contact lenses manufactured thus achieve a greater improvement of vision than if the anterior optics of the contact lens is spherical or toric or determined with the aid of an aberrometer, whereby the aberrations are carefully measured, and that with these values, lenses are made that completely correct this wavefront. Corrections resulting from unilateral measurements with the aid of an aberrometer or adaptive optics take no consideration of adaptation and binocular summation with which the visual acuity is improved by combining information originating from the left and right eyes. In the method according to the invention, determining the right contact lens is not based on aberrometry, but on subjective refraction, bearing in mind adaptation and binocular summation. In the method according to the invention, the amount of correction of higher order aberrations is subjectively determined and is not based on measurements made with an aberrometer, but on characteristic wavefront patterns in patients with keratoconus.

It is noted that in U.S. Pat. No. 8,366,272A, it is described how a special soft contact lens must be applied to a keratoconus eye. The anterior of the lens is aspheric or aspheric-toric and thus wavefront-aberration controlled. However, nothing is stated about the correction of greater order aberrations (HOAs) and/or a method for this.

The invention also relates to a pair of contact lenses manufactured by the method according to the invention.

In addition, the invention relates to a set of fitting lenses for the improvement of visual acuity in patients with keratoconus corrected with rotation-stabilized hard or soft contact lenses. As far as the set of fitting lenses is concerned, the invention is characterized in that the fitting lenses of the set are rotation-stabilized and the set of fitting lenses comprises more than two fitting lenses with increasing sector power of which one sector has a more positive or more negative power than the remaining part of the anterior optics, which sector is located at the inferior part of the rotation-stabilized fitting lens. A contact lens is applied with its posterior part to the eye. The anterior part of the contact lens forms its anterior optics. It has been found that the visual acuity of a keratoconus patient can be improved with a fitting lens with a suitable sector-specific power. By having a set of fitting lenses at one's disposal from which the most suitable fitting lens can be chosen, a suitable fitting lens can be found for every patient or at least almost every patient. Rotation-stabilized contact lenses will not rotate on the eyes. This can be achieved in various ways. It is noted that a sector with a rounded point below the sector shape referred to here is also to be understood here, or a sector that is centred or inclined in order to compensate for the centring or inclination of the contact lens on the eye.

It should be noted that in US0050639A, it is stated that when the inferior part of the contact lens is negative and the superior part is positive, this yields a correction for coma (coma is the greatest error that occurs as a consequence of keratoconus). However, the contact lens known from this has a horizontal dividing line that separates positive and negative powers from each other, wherein a positive power is present on the superior part of the contact lens. This is contrary to the lens according to the present invention.

In order to better find a suitable fitting lens that is close to the ideal fitting lens, an embodiment of the set of fitting lenses according to the invention is characterized in that a number of the fitting lenses have a different curvature and a different power than the remainder of the anterior optics, and that there are fitting lenses with the same curvature and power that have different powers of that sector. Therefore, there are a number of fitting lenses with different powers of the sectors of a lens with a certain curvature and a certain power. Preferably, there are three fitting lenses with different sector powers of each lens with a certain curvature and associated power. The sector powers are, for example, a value of 1, 2 and 3 more positive than the power of the remaining part of the anterior optics.

A further embodiment of the set of fitting lenses according to the invention is characterized in that the sector extends over an angle between 10 and 180 degrees. Preferably, the sector extends over an angle between 60 and 120 degrees and it is even more preferable that the sector be a quadrant. Here, it should be noted that the transition from the sector to the remaining part of the lens is preferably not sharp but runs gradually. The change in power goes gradually over a number of degrees of arc.

### BRIEF DESCRIPTION OF THE DRAWINGS

Below, the invention will be explained in more detail on the basis of drawings in which embodiments of a fitting lens of the set of fitting lenses and the method according to the invention are shown. In these drawings:

FIG. 1 shows a typical wavefront of the uncorrected vision of a patient with keratoconus;

FIG. 2 shows a typical wavefront of a patient with keratoconus corrected with rotation-symmetrical anterior optics of a hard contact lens; and

FIG. 3 shows an embodiment of a fitting lens of the set of fitting lenses according to the invention.

### DETAILED DESCRIPTION OF THE DRAWINGS

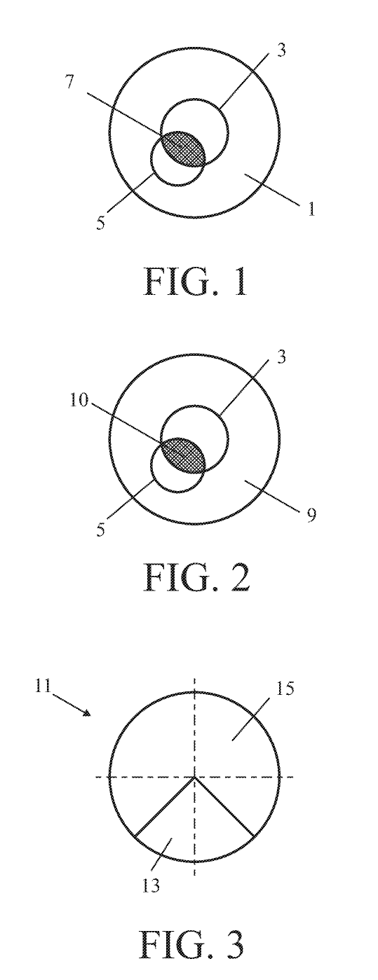

FIG. 1 shows a typical wavefront of the uncorrected optics of a patient with keratoconus. A part 5 of the cornea 1 of the eye that is located partly in front of the pupil 3 is thinner and forms a cone-shaped projection. The shaded part 7 in the inferior part of the pupil 3 of the keratoconus patient represents a more negative power.

In addition, FIG. 2 shows a typical wavefront of a patient with keratoconus corrected with rotation-symmetrical anterior optics of a hard contact lens 9. Here, the shaded part 10 in the inferior part of the pupil 3 of the keratoconus patient represents a more positive power.

FIG. 3 shows an embodiment of a fitting lens of the set of fitting lenses according to the invention. The fitting lens 11 is rotation-stabilized and has a quadrant 13 with a more positive power than the remaining part 15 of the anterior optics. With regard to a soft rotation-stabilized contact lens, the quadrant 13 has a more negative power than the remaining part 15 of the anterior optics. This quadrant is located at the inferior part of the rotation-stabilized fitting lens. A number of such fitting lenses of which the powers of the quadrants differ from each other through increasing power form a set that is used to determine the necessary correction of a contact lens that was fitted on a patient for the correction of aberrations resulting from correction with hard contact lenses in patients with keratoconus or that change too little with the fitting of soft contact lenses. The power of the quadrants of the fitting lenses of the set preferably form a series with a fixed ascending degree of difference.

An embodiment of the set of fitting lenses according to the invention has a number of fitting lenses with different curvatures and different powers than the stated remainder of the anterior optics. The curvature and the power of the remaining part of the anterior optics are calculated for emmetropic eyes.

There are a number (for example, three) of fitting lenses with different powers of the sectors of each lens with a certain curvature and a certain power. The sector powers are a value 1, 2 and 3 times more positive than the power of the remaining part of the anterior optics. In the table below, a set of fitting lenses is shown in which there is a specification of the curvature and power of the remaining part of the anterior optics and of the sectors.

| | Curvature (=radius | Power of the | |
|---|---|---|---|
| Lens | of the posterior part | remaining part of the | Power of |
| number | of the lens) | anterior optics | the sector |
| 1 | 8.40 | +4.00 | +1.50 |
| 2 | 8.40 | +4.00 | +3.00 |
| 3 | 8.40 | +4.00 | +4.50 |
| 4 | 8.20 | +2.00 | +1.50 |
| 5 | 8.20 | +2.00 | +3.00 |
| 6 | 8.20 | +2.00 | +4.50 |
| 7 | 8.00 | 0 | +1.50 |
| 8 | 8.00 | 0 | +3.00 |
| 9 | 8.00 | 0 | +4.50 |
| 10 | 7.80 | −1.00 | +1.50 |
| 11 | 7.80 | −1.00 | +3.00 |
| 12 | 7.80 | −1.00 | +4.50 |
| 13 | 7.60 | −2.00 | +1.50 |
| 14 | 7.60 | −2.00 | +3.00 |
| 15 | 7.60 | −2.00 | +4.50 |
| 16 | 7.40 | −3.00 | +1.50 |
| 17 | 7.40 | −3.00 | +3.00 |
| 18 | 7.40 | −3.00 | +4.50 |

With the set of fitting lens thus obtained, a pair of contact lenses can be manufactured with which the visual acuity of patients with keratoconus that had been corrected with spherical and/or toric hard contact lenses can be improved even more.

The procedure is as follows. First, it is determined which of the patient's eyes has the lowest degree of keratoconus. Then, for that eye, the most effective fitting lens—the one with which the patient can see best—is determined from the set of fitting lenses by applying different fitting lenses of that set of fitting lenses one by one to that eye while the patient looks with both eyes at optotypes and is wearing the contact lens for correction of keratoconus in the other eye that has already been fitted in the known way or that has no contact lens. Thereafter, this is repeated for the other eye of the patient.

In patients in whom keratoconus is corrected by hard contact lenses, fitting lenses with quadrant specific more positive power than the remainder of the anterior optics should be used. In patients in whom keratoconus is corrected with soft contact lenses, fitting lenses with quadrant specific more negative power may improve visual acuity.

Then, spherical fitting lenses with different powers are held one by one in front of each eye in order to determine the basic power of the contact lenses to be manufactured. Then, a contact lens is manufactured for each eye with a power equal to that of the fitting lens that gave the best visual acuity for that eye and that has a sector with a power equal to the sum of the power of the sector of the selected most effective fitting lens for that eye and the power of the fitting lens that gave the best visual acuity for that eye. In the manufacture of the contact lenses, known measures should be taken to ensure that the contact lens is rotation-stabilized, whereby the sector is at the inferior part of the contact lens.

Although in the above the invention is explained on the basis of drawings, it should be noted that the invention is in no way limited to the embodiment shown in the drawings. The invention also extends to all embodiments deviating from the embodiment shown in the drawings within the context defined by the claims. The invention may, for example, also relate to a method for the manufacture of a pair of rotation-stabilized contact lenses for improving visual acuity in patients with keratoconus corrected with soft contact lenses instead of hard contact lenses. In that case, the sectors of the fitting lenses must have a more negative power than the remainder of the anterior optics. The described fitting set may also vary in values (the described fitting set serves only as an example). The lens can also be a scleral lens and have a rim around the lens shown in FIG. 3, which rim rests on a portion of sclera around the cornea during use.

1. Method for the manufacture of a pair of rotation-stabilized contact lenses for improving visual acuity in patients with keratoconus corrected with hard contact lenses, comprising:
providing a set of more than two rotation-stabilized fitting lenses with different anterior optics, whereby a sector of each fitting lens has a more positive power than the remainder of the anterior optics, which sector is located at the inferior part of the rotation-stabilized fitting lens,
determining which eye of the patient has the lowest degree of keratoconus and is thus the better eye,
determining the most effective fitting lens from the set of fitting lenses for the eye with the lowest degree of keratoconus by applying different fitting lenses of the set of fitting lenses one by one to that eye, while the patient looks with both eyes at optotypes, whereby the most effective fitting lens is the fitting lens for that eye regarding which the patient says that they can see best with it,
determining the most effective fitting lens from the set of fitting lenses for the eye with the highest degree of keratoconus by applying different fitting lenses of the set of fitting lenses one by one to that eye, while the patient looks with both eyes at optotypes, and in the eye with the least amount of keratoconus the most effective fitting lens determined earlier is placed, whereby the most effective fitting lens is the fitting lens for the eye with the highest degree of keratoconus regarding which the patient states that they can see best with it; the other eye can be covered for this measurement,
determining the basic power of the contact lenses to be manufactured by holding spherical fitting lenses with different powers one by one in front of each eye, whereby the best basic power is the power of the fitting lenses with which that eye has the greatest acuity, and
manufacturing a contact lens for each eye of the patient with a power equal to that of the fitting lens with which that eye has the greatest acuity, and that has a sector with a power equal to the sum of the power of the sector of the selected most effective fitting lens for that eye and the power of the fitting lens with which that eye has the greatest acuity.

2. Method for the manufacture of a pair of rotation-stabilized contact lenses for improving visual acuity in patients with keratoconus corrected with soft contact lenses, comprising:
providing a set of more than two rotation-stabilized fitting lenses with different anterior optics, whereby a sector of each fitting lens has a more negative power than the remainder of the anterior optics, which sector is located at the inferior part of the rotation-stabilized fitting lens,
determining which of the patient's eyes has the lowest degree of keratoconus,
determining the most effective fitting lens from the set of fitting lenses for the eye with the lowest degree of keratoconus by applying different fitting lenses of the set of fitting lenses one by one to that eye, while the patient looks with both eyes at optotypes, whereby the most effective fitting lens is the fitting lens for that eye regarding which the patient says that they can see best with it,
determining the most effective fitting lens from the set of fitting lenses for the eye with the highest degree of keratoconus by applying different fitting lenses of the set of fitting lenses one by one to that eye, while the patient looks with both eyes at the reference object, and in the eye with the least amount of keratoconus the most effective fitting lens determined earlier is placed, whereby the most effective fitting lens is the fitting lens for the eye with the highest degree of keratoconus regarding which the patient states that they can see best with it,
determining the basic power of the contact lenses to be manufactured by holding spherical fitting lenses with different powers one by one in front of each eye, whereby the best basic power is the power of the fitting lenses with which that eye has the greatest acuity, and
manufacturing a contact lens for each eye of the patient with a power equal to that of the fitting lens with which that eye has the greatest acuity, and that has a sector with a power equal to the sum of the power of the sector of the selected most effective fitting lens for that eye and the power of the fitting lens with which that eye has the greatest acuity.

3. (canceled)

4. A set of fitting lenses for improving the visual acuity of patients with keratoconus corrected with rotation-stabilized hard contact lenses, wherein the fitting lenses of the set are rotation-stabilized and the set of fitting lenses comprises more than two fitting lenses with different anterior optics, of which a sector has a more positive power than the remaining part of the anterior optics, which sector is located at the inferior part of the rotation-stabilized fitting lens.

5. A set of fitting lenses for improving the visual acuity of patients with keratoconus corrected with rotation-stabilized soft contact lenses, wherein the fitting lenses of the set are rotation-stabilized and the set of fitting lenses comprises more than two fitting lenses with different anterior optics, of which a sector has a more negative power than the remaining part of the anterior optics, which sector is located at the inferior part of the rotation-stabilized fitting lens.

6. A set of fitting lenses according to claim 4, wherein a number of the fitting lenses have a different curvature and a different power than said remaining part of the anterior optics, and that there are fitting lenses with the same curvature and power as said remaining part of the anterior optics and that have different powers of the sector.

7. A set of fitting lenses according to claim 4, wherein the sector extends over an angle between 10 and 180 degrees.

8. A set of fitting lenses according to claim 7, wherein the sector extends over an angle between 60 and 120 degrees.

9. A set of fitting lenses according to claim 7, wherein the sector is a quadrant.

10. A set of fitting lenses according to claim 5, wherein a number of the fitting lenses have a different curvature and a different power than said remaining part of the anterior optics, and that there are fitting lenses with the same curvature and power as said remaining part of the anterior optics and that have different powers of the sector.

11. A set of fitting lenses according to claim 5, wherein the sector extends over an angle between 10 and 180 degrees.

12. A set of fitting lenses according to claim 11, wherein the sector extends over an angle between 60 and 120 degrees.

13. A set of fitting lenses according to claim 11, wherein the sector is a quadrant.
